(19) United States
(12) Patent Application Publication
(10) Pub. No.: US 2012/0130875 A2
(43) Pub. Date: May 24, 2012

(54) ASSET ACQUISITION, MANAGEMENT AND OCCUPATION SYSTEMS AND METHODS

(75) Inventors: Wendy Philp, Gleneagle (AU); Bruce Philp, Gleneagle (AU); Keith Burchill, Haigslea (AU); Damian Welshe, The Gap (AU); Paul Raftery, Red Hill (AU)

(73) Assignee: Burchill Consulting Pty Ltd., Haigslea (AU)

(21) Appl. No.: 12/665,643

(22) PCT Filed: Jun. 19, 2008
(86) PCT No.: PCT/AU2008/000884

§ 371 Date: Jun. 16, 2010

(30) Foreign Application Priority Data
Jun. 19, 2007 (AU) 2007903272

(51) Int. Cl. G06Q 40/00

(52) U.S. Cl. 705/35

(57) ABSTRACT

Asset acquisition, management and/or occupation systems and methods are disclosed. One of the methods of acquiring an asset includes a first party approving the asset selected by a second party and the first party purchasing the asset. The method includes the first party and the second party agreeing that the second party has an option or right to purchase, lease, license, or settle or not settle the purchase of the asset from the first party at or before a predetermined time.

### CROSS-REFERENCE TO RELATED APPLICATIONS

The present invention is a U.S. National Phase patent application under 35 U.S.C. §371 of International Application No. PCT/AU2008/000884, filed Jun. 19, 2008, which claims priority to Australian Patent Application No. 2007903272, filed Jun. 19, 2007, both of which are expressly incorporated herein by reference.

### FIELD OF THE INVENTION

The present invention relates to systems and methods for asset acquisition, management and occupation. In particular, but not exclusively, the present invention relates to systems and methods for the acquisition, management and occupation under lease or license or otherwise of property, such as residential, commercial, industrial or other premises and the like. Whilst the present invention will be described in relation to the acquisition of property, it is envisaged that the systems and methods of the present invention can be applied to the acquisition or occupation of other assets, such as vehicles or animals.

### BACKGROUND TO THE INVENTION

Owning property, and in particular home ownership and commercial and industrial premises, is the goal of many consumers and business people. Home ownership and the ownership of business premises provides a sense of security, creates equity against which money can be borrowed and avoids the payment of rent to a landlord, which does not contribute to the wealth of the tenant. Furthermore, the home owner or business premises owner is relatively free to modify the property as they wish in accordance with any required planning permission without the need to first seek approval from the landlord.

However, the ownership of such property can be difficult to achieve for many because of the high cost involved. Often a substantial deposit is required before a home loan or business premises loan can be authorized. Even where a deposit is not required and 100% mortgages are provided by financial institutions or the like, the mortgage repayments can be unmanageable for many and are typically significantly higher than paying rent. An increasing spiral of debt is often the result. Furthermore, before mortgages or home loans or business loans are approved by the lending institution, the applicant(s) is/are subject to a credit rating check or analysis. For many people a bad credit history can prevent them from being approved for a mortgage, home loan or business loan in the future. This can be the case where defaulting on loan repayments or the like occurred many years earlier, where such defaults were not necessarily within the control of the applicant(s) or where the credit history is inaccurate.

There are a wide range of mortgages available from an equally large range of mortgage providers. Mortgages have varying terms and conditions including fixed and variable interest rates and repayments, draw-downs, penalties and the like. However, one common feature of mortgages is that the mortgage provider, whether it is a bank or other institution, has an interest in the property which gives it the ability to force sale of the property until all repayments have been made. If the conditions of the mortgage are breached and are not remedied within a specified time frame, the mortgage provider can foreclose on the mortgage. The mortgagor loses legal title to the property and typically has a debt to service. Furthermore, if the mortgagor changes their mind about the property, their only option is to sell the property and repay or transfer the loan.

A yet further problem associated with achieving home ownership or business premises ownership is concerned with timing. In competitive environments such as real estate markets, once a property comes on the market, it can be sold rapidly. If someone finds a property that fits their criteria, financing the purchase can often be a stumbling block and in the absence of securing financing in a prompt manner, the property is often purchased by someone else.

Hence, satisfactorily obtaining mortgages can be a barrier to property ownership and in particular home ownership. Mortgages provide little security for the mortgagor and favor the mortgagee to protect them in respect of the large sum of money loaned to the mortgagor and the associated risk. There is a need for a viable commercial alternative to mortgages that addresses or at least ameliorates one or more of the aforementioned problems. Many of the aforementioned problems are also applicable to acquiring assets other than property and in particular high value assets.

In this specification, the terms “comprises”, “comprising” or similar terms are intended to mean a non-exclusive inclusion, such that a method, system or apparatus that comprises a list of elements does not include those elements solely, but may well include other elements not listed.

### SUMMARY OF THE INVENTION

In one form, although it need not be the only or indeed the broadest form, the invention resides in a method of acquiring an asset including:

a first party approving the asset selected by a second party;

a first party purchasing the asset; and

the first party and the second party agreeing that the second party has an option or right to purchase, lease, license, settle or not settle a purchase of the asset from the first party at or before a predetermined time.

Preferably, the second party is approved by, or to the satisfaction of, the first party. Approval of the second party may include the first party setting an upper limit on the cost of the asset to be acquired, leased or licensed, and/or approving or disapproving of specific assets sought to be acquired by, leased to or licensed to the second party.

In one aspect of the invention, the asset is a property, such as a house, unit or apartment, and the method may include the second party, or a relation thereof, occupying the property during at least part of the predetermined time. However, the present invention is not limited to residential property and it will be appreciated that the present invention is also applicable to commercial, industrial or other types of premises. Furthermore, the present invention is not limited to the acquisition and occupation of buildings. The present invention can also apply to the acquisition and/or occupation of land, vehicles, animals, such as, but not limited to, racehorses and vessels, such as, but not limited to, recreational vehicles, yachts, cruisers etc.

The method may also involve the first party acquiring other goods and/or services to modify or improve the asset.

Preferably, the first party and the second party enter into a purchase contract and/or other contract over an extended term and the method includes the second party periodically paying or agreeing to pay payments to the first party. The payments can be made immediately, progressively in installments or otherwise, such as at one or more future date(s) predetermined by the first party, the second party or both.

Preferably, the payments include a first component in the form of an occupancy fee and a second component in the form of a collateral risk payment and a third component in the form of a savings component. The savings component is invested on behalf of the second party.

The collateral risk payments reflect the risks borne by the first party in undertaking the purchase of the asset.

The method may include the second party exercising their option or right to purchase, lease, license, settle or not settle on the purchase of the asset before or at expiry of the predetermined time.

Exercising their option or right to purchase or settle on the purchase of the asset either before or on expiry of the predetermined time may include the first or second party arranging a conventional mortgage.

If the second party exercises their option or right to purchase or settle before the predetermined time, the method may include the second party paying break fees to the first party.

The method may include the second party declining their option or right to purchase, or exercising their right not to settle on the purchase of, the asset at or before expiry of the predetermined time. Where the asset is a property, this may include the second party vacating the property within a predetermined time from declining their option. If the second party declines their option or right to purchase, or exercises their right not to settle, the method may include the second party paying break fees to the first party.

The method may include the first party exercising a put option under terms of the agreement requiring the second party to either exercise or decline their right or option to purchase, lease, license or settle the purchase of the asset.

The method may include the second party exercising under terms of the agreement their right not to settle the purchase of the asset and hand back possession of the asset to the first party. Where the second party neither exercises nor declines their option or right to purchase, or not to settle on the earlier purchase of the asset, the second party may be considered to be defaulting on the term purchase, lease or license agreement and the method includes the first party or another party repossessing the asset.

Exercising or declining their option or right to purchase, lease, license or not to settle or complete the earlier purchase of the asset may include the second party receiving at least part of the invested savings proportion of the payments.

The method preferably includes the first party providing the second party with a computer system or other communication device and other information that enables the second party at regular intervals to assess alternative strategies available to the second party in current market conditions to assist the second party to decide whether or not to exercise or decline their purchase or option to purchase or to switch to a traditional mortgage, and otherwise communicate with the first party.

This invention, together with the computer system or other communication device, allows the second party to assess for the first time their best alternative time or times at which to move out of or into mortgage products having regard to prevailing market conditions.

The method may include providing data storage and/or exchange facilities for the storage and/or exchange of financial and/or valuation information or other particular aspects or attributes relating to the asset and/or its financing, the data storage and/or exchange facilities accessible by the first party and/or the second party

In another form, the invention resides in an asset acquisition, management and/or asset occupation system comprising:

an input device coupled to be in communication with a processor;

wherein, in response to data about the asset entered via the input device, computer program code components are executed by the processor to determine whether said asset is an approved asset; and

wherein, for an approved asset, computer program code components are executed by the processor to generate an agreement between the first party and the second party that provides the second party with an option or right to purchase, lease, license, settle or not to settle on a purchase of the asset from the first party at or before a predetermined time.

The system further comprises computer program code components to effect the aforementioned actions of the aforementioned method.

In a further form, the invention resides in a method of acquiring, managing and/or occupying assets including:

a first party acquiring a plurality of mortgages or other funds with a mortgage provider or other fund provider for a plurality of assets, each said asset selected by one of a plurality of second parties and approved by the first party;

the first party agreeing with each of the second parties that the relevant second party has an option or right to purchase, lease, license and/or not to settle on the acquisition of their respective asset from the first party at or before a predetermined time.

Preferably, the method includes the first party entering into a purchase contract and/or other contract or option agreement over an extended but predetermined term with each second party and each second party periodically paying payments, or agreeing to make payments in the future at a predetermined date or dates, to the first party.

The method preferably includes investing a proportion of the payments on behalf of the second parties, either immediately or in the future.

In a yet further form, the invention resides in a machine readable medium having recorded thereon a program of instructions for causing a machine to perform a method of acquiring an asset including:

a first party approving the asset selected by a second party;

the first party purchasing the asset; and

the first party and the second party agreeing that the second party has an option or right to purchase, lease, license, settle or not settle on a purchase of the asset from the first party at or before a predetermined time.

Further features and forms of the present invention will become apparent from the following detailed description.

### BRIEF DESCRIPTION OF THE DRAWINGS

By way of example only, preferred embodiments of the invention will be described more fully hereinafter with reference to the accompanying drawings, wherein:

FIG. 1 shows a first part of a flowchart representing a method of asset acquisition in accordance with embodiments of the present invention;

FIG. 2 shows a second part of a flowchart representing a method of asset acquisition in accordance with embodiments of the present invention;

FIG. 3 is a schematic representation of part of an asset acquisition system in accordance with embodiments of the present invention;

FIG. 4 is a schematic representation of another part of the asset acquisition system in accordance with embodiments of the present invention;

FIG. 5 is a first part of a workflow diagram illustrating methods in accordance with embodiments of the present invention;

FIG. 6 is a second part of the workflow diagram shown in FIG. 5;

FIG. 7 is a third part of the workflow diagram shown in FIG. 5; and

FIG. 8 is a fourth part of the workflow diagram shown in FIG. 5.

Skilled addressees will appreciate that elements in the drawings are illustrated for simplicity and clarity and have not necessarily been drawn to scale. For example, the relative dimensions of some of the elements in the drawings may be distorted to help improve understanding of embodiments of the present invention.

### DETAILED DESCRIPTION OF THE INVENTION

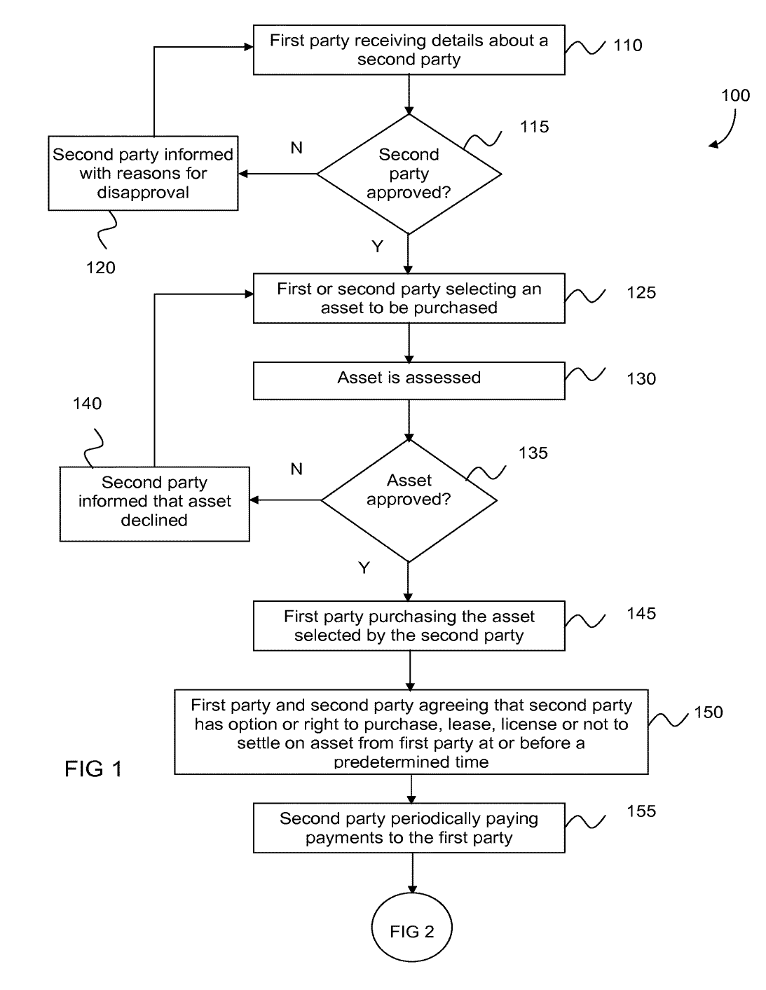

Referring to FIG. 1, a method 100 of acquiring and/or occupying an asset is provided in accordance with embodiments of the present invention. The method includes at 110 a first party receiving details about a second party to assess the second party for suitability. The second party can be approved directly by the first party or by an agent of the first party. Approval of the second party can include the first party setting an upper limit on the cost of the asset to be acquired or other criteria around the class or age or location or description of assets capable of acquisition. Approval of the second party can include verifying whether the second party is insurable for term life cover to the value of the asset to be purchased and trauma and total and permanent disablement (TPD) cover to the value of the periodic payments payable to the first party, and the first party being able to arrange such insurance from underwriters acceptable to the first party at the cost of the first party.

Embodiments of the invention may include the first party arranging or procuring the arranging of residual value insurance in relation to the asset to underwrite the residual value of the asset at the predetermined time or times.

If the second party is not approved at 115, the method 100 can include at 120 the second party being informed accordingly thus providing the second party the opportunity to address where possible the one or more deficiencies that prevented approval, such as insurance. In all embodiments, the first party arranges or procures the arrangement of suitable insurance for the second party to mitigate risk carried by the first party in the event that the second party is either unable to make the periodic payments for a period during the term or fails to (or exercises their right not to) settle on the purchase or becomes deceased during the term of the agreement. Alternatively, the method can end where the reasons for not being approved are not addressable.

If the second party is approved at 115, the method includes at 125 the first party or the second party selecting an asset to be purchased. According to some embodiments, the method can include the first party or the second party selecting any goods and/or services to be acquired to modify or improve the asset. For example, if the asset acquired is land, the goods and services to be acquired can be building materials and/or building services to construct a property on the land. At 130 the asset is assessed and either approved or declined by, or on behalf of, the first party at 135. Where the asset is declined by, or on behalf of, the first party, the second party is informed at 140 and the first party or second party can select an alternative asset at 125. At 140, the second party can also be informed of the one or more reasons that the asset was declined in an attempt to increase the likelihood of a subsequent asset selected by the first or second party being approved by the first party. Where the asset is approved by the first party at 135, the method includes at 145 the first party purchasing the asset selected by the second party and approved by the first party, including acquiring any agreed goods and/or services to modify or improve the asset. A small holding deposit is paid to the first party by the second party.

The assessment criteria for the asset may include, but is not limited to, site location, structural approvals, drawings and/or the age of the asset.

At 150, the method includes the first party and the second party agreeing that the second party has an option or right to purchase, lease, license, settle or not settle on the purchase of the asset from the first party at or before a predetermined time. According to some embodiments of the present invention, the method includes the first party and the second party entering into a first contract in the form of a purchase contract with an extended period for settlement and a second contract that specifically governs the reduction in risk to the second party. The second contract effects a lower risk option to the second party compared to a conventional mortgage during the term of the agreement. The invention allows the second party to monitor in electronic form on a regular basis during the term of the agreement their respective financial positions and legal options as envisaged under the first and second contracts. The invention allows the first party to communicate to the second party at regular intervals new opportunities which emerge in relation to ongoing funding and/or ownership of the asset. The purchase contract can contain special conditions and/or a pre-set purchase price for the asset at or before the end of the predetermined period.

At 155, the method includes the second party periodically paying payments to the first party. The payments are adjusted by a preset Consumer Price Index (CPI) indicator or equivalent during the predetermined period and comprise a first component in the form of an occupancy component and a second component in the form of a collateral risk component related to risks borne or managed by or on behalf of the first party and a third component in the form of a savings component. The occupancy component or occupancy fee and the second component cover costs incurred and risks borne in relation to the future market value of the asset by the first party in purchasing and holding the asset at 145 for the agreed term and taking the risks that the second party does not settle on expiry of the term. The savings component comprises an investment component.

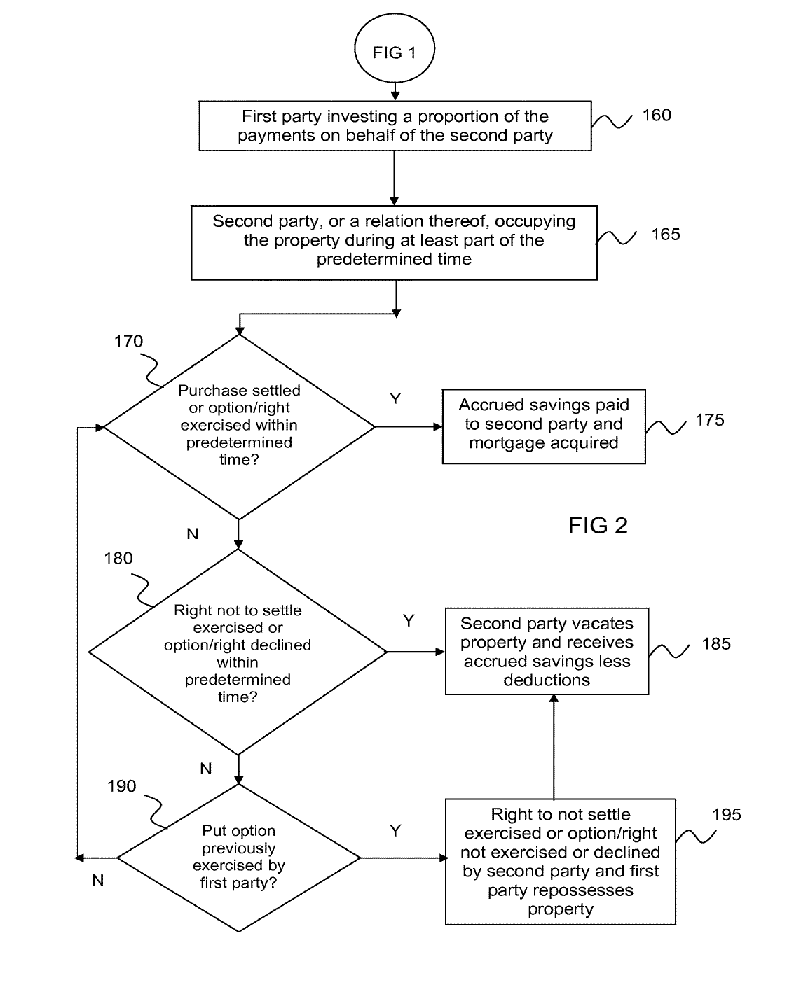

With reference to FIG. 2, preferred embodiments of the method of the present invention include at 160 the first party, or an independent stakeholder, investing the third component (referred to in some embodiments as Progressive Savings Payments (PSP)) of the payments on behalf of the second party in, for example, an investment scheme, such as one or more managed funds, cash management trusts, savings accounts or other financial mechanisms. The second component (referred to in some embodiments as Collateral Risk Payments (CRP)) compensates the first party for the risks borne by it in the agreement, such as the risk of non completion, loss of capital growth from the asset should the market valuations vary during the term more than the pre-agreed percentage within the term and the cost of insurance premiums, to cover the second party.

According to some embodiments of the invention, the asset is a property, such as a house, unit or apartment, or a commercial or industrial property, and the method includes at 165 the second party, or a relation or associate thereof, occupying the property during at least part of the predetermined time. In other embodiments of the invention, the asset is a property leased or licensed to the second party, either for residential, commercial, industrial or retail use, or a combination thereof, and the method includes at 165 the second party, or a relation thereof, occupying or allowing one or more others to occupy, either on a strata title, lease, license or other basis approved by the first party or otherwise, the property during at least part of the predetermined time.

In further embodiments of the invention, the asset is a vehicle and the second party, or a relation or associate thereof, must utilize the vehicle within the predetermined time. Utilization of the vehicle can require the second party or a relation or associate thereof, accruing a threshold distance, such as a minimum number of kilometers/miles, within the predetermined time.

The present invention can also apply to the acquisition, management and/or occupation of land, such as, but not limited to, individual and multiple plots of land, animals, such as, but not limited to, racehorses, and vessels, such as, but not limited to, yachts, cruisers etc. For example, where the asset is an animal, the aforementioned reference to accruing a threshold distance, such as a minimum number of kilometers/miles, within the predetermined time can refer to the animal traversing a threshold distance, such as a racehorse racing a threshold distance, in the predetermined time.

The method includes at 170 the second party exercising their option or right to purchase or settle or not settle the purchase of the asset before or at expiry of the predetermined time. According to some embodiments, the predetermined time can be 5, 6, 7 or 10 years for conventional dwellings or other assets or might be some other period, such as 4 years. Exercising their right to settle or option or right to purchase the asset includes the second party arranging or procuring a conventional mortgage or chattel lease for the asset at 175. If the second party exercises their option or right to purchase, settle or not settle before the predetermined time, the method can include the second party paying break fees to the first party.

A particularly advantageous feature of the present invention is that during the predetermined time, or other time between commencing the agreement and exercising their rights (including by way of exercising an option or exercising their rights under special conditions in the purchase agreement), the third component payments (referred to in some embodiments as the Progressive Savings Payments) paid to the first party at 155 and invested have accrued resulting in a deposit or lump sum (referred to in some embodiments as an Accumulated Savings Fund (ASF)). Furthermore, another particularly advantageous feature of the present invention, which may apply in some embodiments, is that at the predetermined time, as an incentive to the second party to settle their purchase contract or exercise their option or right to purchase the asset, an amount is returned, applied or offset against the pre-agreed purchase price at settlement. In one particular embodiment, this amount is similar to the collateral risk payments (CRP) less an amount equal to the insurance premiums received by the first party during the term, less an amount which equals 10% (or such other pre-agreed percentage, including zero) of any capital growth above the pre-agreed purchase price, as determined by an independent valuation.

Hence, where the second party proceeds to settle early at the end of year 3 or exercises their right or option to purchase, lease or license the property, an amount similar to the collateral risk payments (CRP) less an amount equal to the insurance premiums outlaid by the first party, less an amount which equals a pre-agreed percentage of any capital growth, as determined by an independent valuation, above the pre-agreed purchase price may be returned to the second party. This results in an amount being payable to the second party and which they can use along with their accumulated savings amount as a deposit for a conventional mortgage. Where the second party exercises their right not to settle or exercises their option to terminate the purchase contract, or otherwise defaults on the agreement, the second party has no entitlement to the risk reward payment and the first party applies their CRP payments as compensation for the risk crystallized and the second party only receives the adjusted ASF.

In other embodiments, the amount returned, applied or offset against the pre-agreed purchase price at settlement is a different amount. This amount is returned, applied or offset against the pre-agreed purchase price at settlement because the risks borne by the first party during the term have not materialized and may be used by the second party as part of their deposit for a conventional mortgage. In one embodiment of the invention, at the full term, i.e. at the end of the agreed predetermined time, the combined accumulated amount will be in the region of 20% of the purchase price of the asset. In other embodiments, the amount returned, applied or offset is calculated to ensure that the second party has accumulated at least sufficient funds at the end of the agreed predetermined term to obtain a traditional mortgage. The calculation can be based on, for example, the amount required to secure the traditional mortgage for the price of the asset at the interest rates, mortgage term and other factors of the traditional mortgage. In some embodiments, no amount is returned, applied or offset.

In another alternative embodiment of the invention and its technical environment, at the time of entry into the agreement, the pre-agreed purchase price on settlement is first ascertained without regard to actual capital growth anticipated. In circumstances where higher levels of actual capital growth in the value of the asset occur during the term of the agreement, the pre-agreed purchase price may be increased by a pre-agreed percentage of any capital growth above the otherwise pre-agreed purchase price at the time of entry into the agreement. The amount of the increase in purchase price is termed the upside risk payment which comprises a possible fourth component of the payments made to the first party to purchase the asset.

Alternatively, the method includes at 180 the second party exercising their right to not settle or declining their option or right to purchase the asset before expiry of the predetermined time. In other words the second party is exercising their right to terminate the purchase agreement or the put and call agreement. Where the asset is a property, this can include at 185 the second party vacating the property within the predetermined time. Where the second party exercises their right not to settle or declines their option or right to purchase the asset, the second party nonetheless receives a lump sum resulting from the savings payments paid to the first party or another party and invested resulting in their ASF. However, some of the ASF will be deducted by the first party to pay for repairs to the property where required to return the property to an “as new” condition due to occupancy of the property by the second party. If the second party declines their option or right to purchase, or exercises their right not to settle, the second party may be required to pay break fees to the first party.

In some embodiments, the method 100 includes at 190 the first party exercising a put option under one or more terms of the agreement requiring the second party to either exercise or decline their option to purchase the asset. The put option will be exercised by the first party if the second party has not exercised its call option. If the put option is exercised by the first party, that is where the second party neither exercises its right to not settle nor declines their option to purchase the asset within a predetermined time, the second party is considered to be defaulting on the agreement and the first party cancels the lease or right to occupy under the agreement and re-takes possession of the asset at 195. According to some embodiments, another party other than the first party can repossess the asset. The second party vacates the property and the Accumulated Savings Fund (ASF) is paid to second party less the cost of returning the property to an “as new” condition. There may also be a penalty payment for defaulting on the agreement which the invention and its technical environment identifies and quantifies readily to the first party as and when required, having regard to the second party's choice of options, and timing of making those decisions. The asset is made available for re-optioning to another second party via the present invention, which identifies the market value at which this should occur at the relevant time between the first party and that other second party.

At any stage, the second party can exit the system and method of purchase with the outcomes to each party readily identifiable by the present invention. The second party vacates the property, handing back possession to the first party. The accumulated savings fund (ASF) is paid to the second party less the cost of returning the property to an “as new” condition. Restoration of the property is undertaken by contractors who have been pre-approved by the first party.

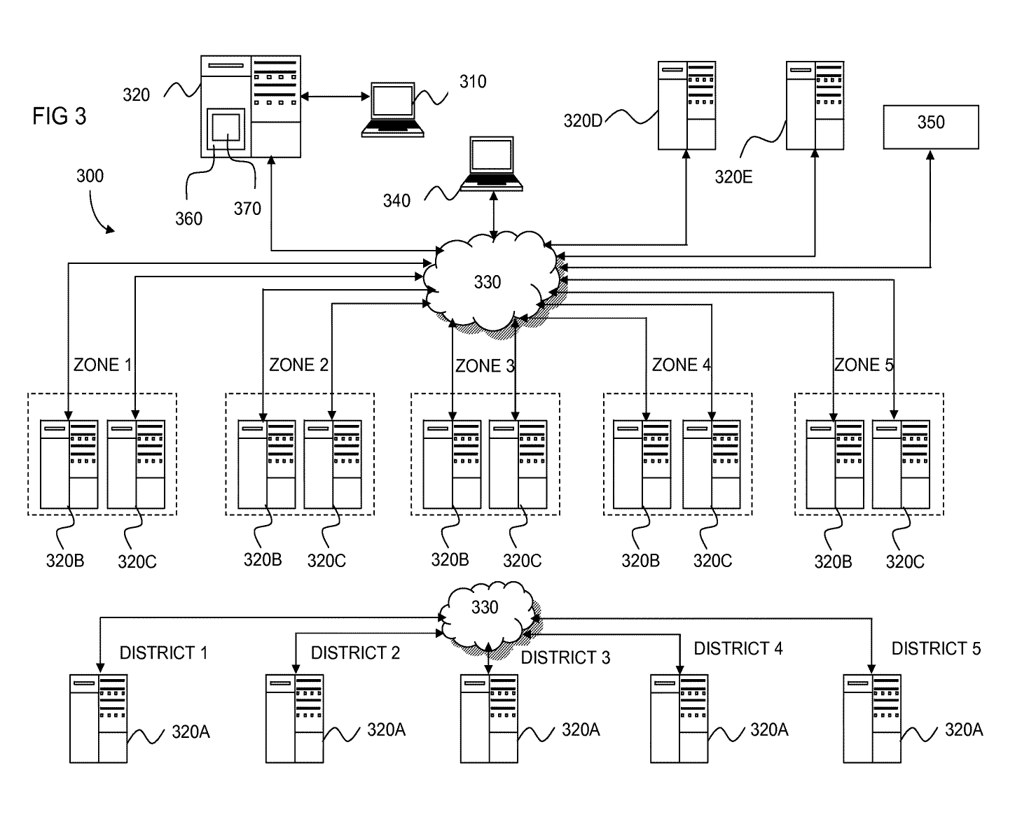

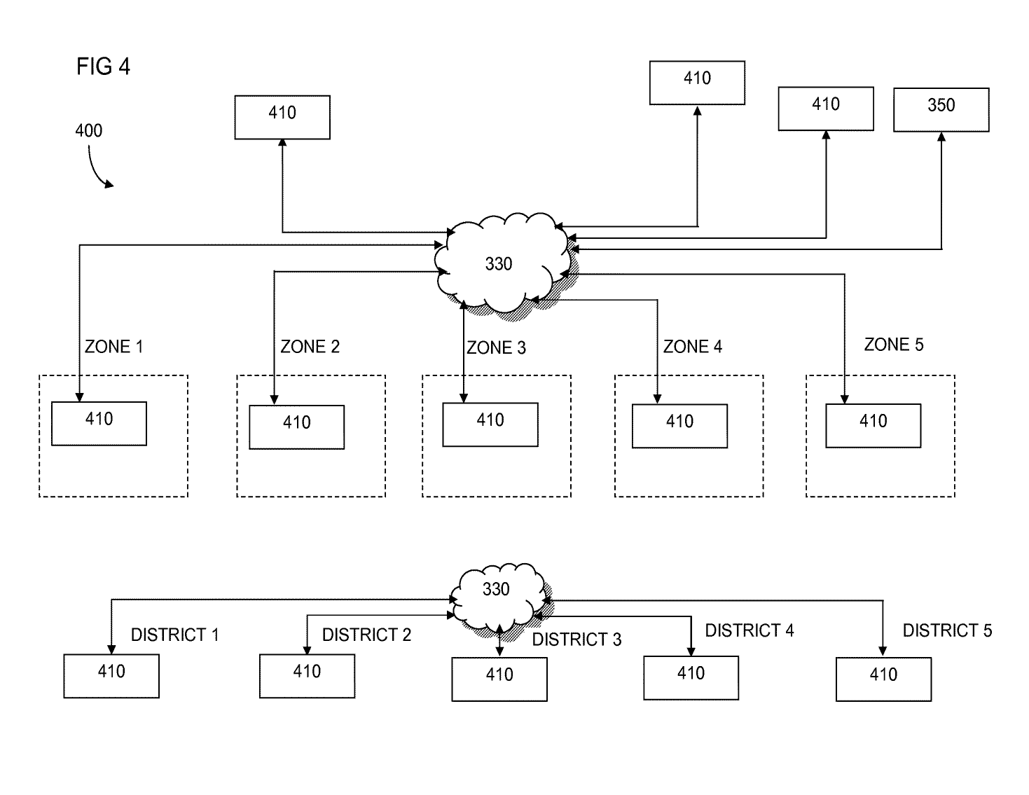

According to some embodiments of the invention, the aforementioned method can be implemented in the asset acquisition systems 300 shown in FIGS. 3 and 4. With reference to FIG. 3, the system 300 comprises at least one input device 310, such as a conventional terminal or workstation, comprising a display, a mouse and a keyboard, or a touch-sensitive screen, coupled to be in communication with at least one processor, such as a server 320. Where the input device 310 is remote from the server 320, communication between the input device 310 and the server 320 can be via a communications network 330, such as the Internet.

As shown in the embodiment of FIG. 3, the system 300 can comprise a plurality of servers 320 each coupled to a plurality of input devices 310. However, FIG. 3 does not show input devices 310 coupled to each server for the sake of clarity of the drawing. The system shown in FIG. 3 comprises five servers 320A accessible by district offices, “shop fronts” or other sites, which can be visited by customers (referred to as second parties herein). Each server 320A is coupled to be in communication with the communication network 330 by ADSL 1500/256 lines. In this example, the servers 320A are in the form of Windows® Small Business Servers (SBS) 2003 each accessed by ten users via input devices 310 in the form of workstations.

According to some embodiments, training server 320B and a further server 320C are also coupled to be in communication with the communication network 330 by ADSL 1500/256 lines, which can be accessed by a range of district offices. Alternatively, the training server 320B and further server 320C are replicated in different zones within a state, country and/or overseas. In the embodiment shown, training server 320B and a further server 320C are provided for a number of Australian state-based zones (zones 1 to 4) and an overseas zone in the form of a New Zealand zone (zone 5).

According to one embodiment, on a regional level, such as a particular country in which the invention is implemented, processor 320D is in the form of a Zebedee server running Windows®XP Pro SP2 and a Microsoft Operations Manager (MOM) database server running Red Hat Enterprise Linux 4AS are coupled via a 1 GB switch to the communications network 330 via a SHDSL 2 mb/2 mb line. Alternatively, a single server can be provided, which in the embodiment shown in FIG. 3, services overseas jurisdictions in which the present invention is implemented. A further server 320E for franchise services and router termination 350 are also coupled to be in communication with the communication network 330 by ADSL 1500/256 lines. It should be appreciated that alternative servers servicing alternative numbers of users and coupled via alternative communication lines can be employed.

The system 300 can also comprise one or more tablet PCs coupled to a printer and wirelessly in communication with the server 320A. The tablet PC can be used to gather information on the second party and/or the asset and transmitted to the server 320A. A digital pen used in conjunction with a sensitive screen and wirelessly in communication with the server 320A, for example via a mobile telephone, can also be used for this purpose.

The system 300 also comprises a computer system 340 or other communication device provided by the first party that enables the second party to exercise their right not to settle or decline their right or option to purchase, lease or license the asset and otherwise communicate with the first party. The computer system 340 or other communication device can be provided in the asset being purchased, such as a property.

FIG. 4 shows a communications system 400 for use in conjunction with the system 300 shown in FIG. 3. The system 400 comprises a plurality of routers 410, such as Cisco® 2800 routers, provided at the district, zone and regional levels corresponding to the levels shown in FIG. 3. Each router 410 is coupled to be in communication with the communications network 330 via suitable communication lines, such as ADSL 1500/256 lines. Each router 410 has the capacity for five ISDN timeslots, a conference connection, a range of handset connections, such as 9, 10, 15, 21 or 23 handset connections, fax connections, one monitored alarm, two PSTN connections and one or more ADSL connections. However, it will be appreciated that alternative routers with different capacities can be employed and routers with difference capacities and levels of functionality can be employed at the different levels.

In the system 300, in response to data about the second party entered via the input device 310, tablet PC or digital pen, computer program code components are executed in the processor, such as server 320, to determine whether the second party is approved. Alternatively, data about the second party can be entered on a tablet PC or other portable data entry device and wirelessly transmitted to the server 320. This determination can include setting an upper limit for the second party on the cost of the asset to be acquired.

As described above in relation to the method 100, an approved party selects an asset to be purchased, leased or licensed and details of the selected asset are provided to the first party and to the server 320. Computer program code components are executed in the server 320 to determine whether the selected asset is an approved asset.

For approved second parties, once the approved asset is purchased by the first party, computer program code components are executed in the server 320 to generate an agreement between the first party and the second party that provides the second party with an agreement containing the right to settle or not to settle or an option or right to purchase, lease or license the asset from the first party within a predetermined time.

The second party periodically pays payments to the first party and computer program code components are executed to cause a proportion of the payments to be invested on behalf of the second party. These particular computer program code components can be executed in one of the servers 320 or in other embodiments, in servers of financial institutions. According to some embodiments, the payments from the second party are first routed through an independent stakeholder fund. A proportion of the payments corresponding to the PSPs are retained and the remainder is invested on behalf of the second party.

Where the asset is a property, following occupancy of the property by the second party, or a relation or associate thereof, during at least part of the predetermined time, the second party can exercise their right to settle or not to settle or decline their right or option to purchase the property within the predetermined time online via a secured website, for example, using computer system 340 or other communication device, such as a mobile phone, Personal Digital Assistant (PDA) or other mobile computing device. The second party can check an appropriate box or indicate by any other suitable means via the website that they wish to exercise or decline their right or option to purchase the property or to settle or not settle. In any of these cases, computer program code components can be executed to effect their choice.

The system of the present invention includes a second party or customer contact management module having three main components. A first component records all relevant personal and contact details for the second party. A second component records all communications between the first party and the second party, such as emails, phone calls and meetings. Details from the first component are automatically copied therefrom when the second component is activated. A third component comprises referral information and additional personal information. All information is searchable on various fields, and emails are automatically generated when certain data is entered triggering certain events.

The system of the present invention includes an asset assessment module that enables information about the asset to be recorded. For example, where the asset is a property, tick boxes and data fields relating the presence, absence and condition of hot water systems, fencing, garden sheds, electrics, floor and wall coverings etc. are completed by, or on behalf of, the first party. The asset assessment module is also capable of accepting images of the property and the completed record is searchable by any potentially useful field, such as property number, address, date of inspection. The asset management module also enables the contract work in relation to the asset to be monitored. All work ordered, the progress of the work and completed work is recorded in relation to each asset.

The system of the present invention includes an IT equipment management module that records and tracks all details relating to IT equipment in the system, such as date of purchase, lease or license, maintenance contracts, renewal dates, depreciation charts, serial numbers and the like. This enables monitoring of IT equipment provided to the second parties as well as the remaining IT equipment in the system. An associated IT help-desk tracking module enables staff using the system to seek efficient responses to IT queries. In some embodiments, the IT help-desk tracking module is also accessible to the second parties where they have a query in relation to the IT provided to them by the first party.

The system of the present invention includes a performance appraisal module that enables staff using the system to be professionally assessed. Prompts for periodic reviews are automatically generated.

With reference to FIG. 3, a machine readable medium 360 is provided coupled to be in communication with the processor 320. The machine readable medium 360 has a program of instructions recorded thereon for causing a machine, such as the processor 320, which can be in the form of a server, to perform a method of acquiring an asset in accordance with embodiments of the present invention. The program of instructions includes computer program code components 370 executed by the processor to determine for the first party whether the asset selected by the second party is an asset approved by a first party. The program of instructions includes, for an approved asset, computer program code components executed by the processor to effect purchasing of the asset by the first party. The program of instructions includes computer program code components executed by the processor to generate an agreement between the first party and the second party that provides the second party with an option or right to purchase, lease, license, settle or not to settle on a purchase of the asset from the first party at or before a predetermined time.

It will be appreciated that the program of instructions includes computer program code components 370 for performing the actions of the embodiments of the methods of acquiring an asset as described herein.

An example of some figures associated with the methods of the present invention are provided in Table 1 below:

TABLE-US-00001 TABLE 1 $ Year 3 Payments Occupancy Fee (OF) 30,285 Collateral Risk Payment (CRP) 21,594 Progressive Savings Payments (PSP) 2,741 Total Periodic Payments 54,621 Take-back at the end Year 3 Accumulated Progressive Savings Payments 8,722 Adjustments Refurbishment costs −2,163 Total Deposit Repaid to Second Party 6,558

The refurbishment costs are deducted from the ASF and the balance is returned/repaid to the second party resulting in an ASF value of $6,558.

According to another aspect, the present invention resides in a method of acquiring, leasing or licensing assets including a first party acquiring a plurality of mortgages with a mortgage provider for a plurality of assets. Each of the assets is selected by one of a plurality of second parties and is approved by the first party. The method includes the first party agreeing with each of the second parties that the relevant second party has a right not to settle the purchase, lease or license, or an option to purchase their respective asset from the first party within a predetermined time. According to some embodiments each agreement is a purchase agreement with an extended settlement period and another agreement is used under which each second party periodically pays payments to the first party. As described above, the method includes investing a proportion of the payments on behalf of the second parties. Within the predetermined time under the agreement, each party can exercise the right or option to purchase the asset or exercise their right to terminate the agreement and vacate the property. Whether the second party exercises their right to purchase or terminate, the second party may receive a lump sum that they can use toward the purchase of the same or a different asset. The first party is able to negotiate better rates for a large volume of mortgages with a mortgage provider and mitigate the risk associated with a large volume of mortgages by pre-approving both the second parties and the assets and through procuring a large volume of insurance.

A comparison of embodiments of the present invention with a conventional mortgage scheme will now be provided to illustrate the benefits of the systems and methods of the present invention. The comparison is shown in Table 2:

TABLE-US-00002 TABLE 2 Comparison 1 Embodiments of 5% deposit invention Differential Deposit 20,000 700 Grant 0 0 Establishment costs Mortgage Insurance 7,855 Transfer Stamp duty 6,000 Loan Establishment Fee 600 300 Legal costs 600 600 Loan Stamp Duty 745 Registration of Title Transfer 654 Registration of Mortgage 115 Total 36,568 1,600 34,968 Monthly costs Monthly Payments 3,313 4,135 Conventional Rates & Maintenance 250 Mortgage costs Life Insurance (couple) 210 Per annum 46,236 House insurance 80 Per Week 889 Total 3,853 4,135−65 5 year comparison 1st month commitment 415,799 1,600 Initial outlay 36,568 1,600 Outlays over 59 months 263,896 245,550 18,345 Walk away after 3 years Fire sale @ 85% of value 387,996 Accumulated savings 0 21,435 Selling costs 10,700 0 Principal owing on loan 367,022 0 Nett position 10,275 21,435 11,160 Settlement at 59 months Property Valuation 486,661 Purchase price 437,882 Equity Accumulated 41,811 Amount saved/FHOG 15,107 Balance to settle 422,775 Less deposit (loan reqd) 422,075 Principal owing on loan 356,088 Loan Stamp Duty 1,688 Purchase costs 1,000 Initial outlay in Y5 dollars 52,815 1,600 Comparative debt position 408,902 426,364−17,461 Summary Initial outlays 36,568 1,600 Outlays over 59 mths 263,896 245,550 Exit position at 3 years 10,275 21,435 Debt Position after 5 years 408,902 426,364 Analysis Increase in equity in Property 77,759 60,297 Outlays over the 59 mths 18,345 Debt Position after 5 years 17,461 Return on total Cost 29.47% 24.56% Return on initial Investment 112.64% 3668.59% Fire-sale Risk Analysis −26,293 19,835

For example, with reference to Table 2, in the current market, a deposit of $34,968 is required to purchase an asset in the form of a $400,000 house with a mortgage from a major bank. The mortgage costs $3,853 per month, which is equivalent to $46,236 per annum or $889 per week. Value is lost if a fire sale is necessary after 3 years because of, for example, a relationship breakdown, death or loss of income, for example, due to unemployment. Embodiments of the present invention effectively incubate the second party to an equity position in the property of their choice, with immediate occupation and limited downside risk in the first 5 years, because reinsurance for adverse property markets is instituted.

The second party invests $34,968 elsewhere to earn a greater return, less $1,600 required up front. The return on the investment is used to pay the extra $65 per week to remove downside risk and benefit from the upside. $18,345 can be saved over 5 years in outlays, by adding $17,461 to your debt in 5 years time, thus getting a foothold on the property ladder. The second party is $11,160 better off if they are forced to ‘walk away’ from the property due to adverse circumstances after 3 years. Equity for the future of $60,297 can be accumulated over 5 years if the property increases by only 4.5% per annum. This is equity that couldn't have been accumulated if the second party continued to rent to save a deposit.

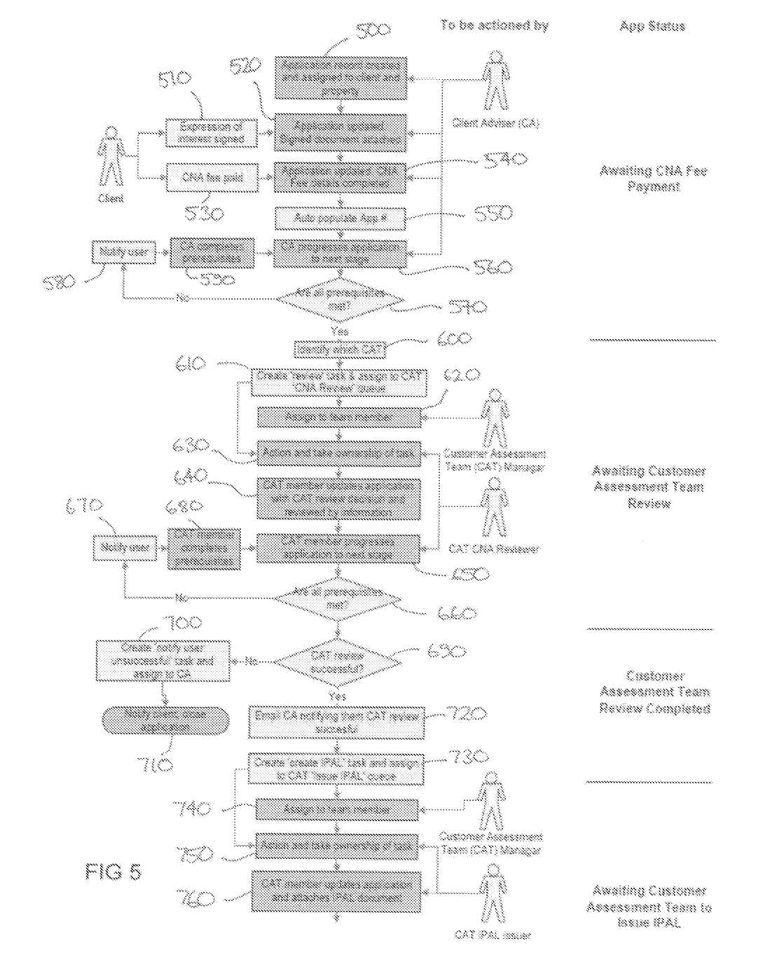

Reference is now made to FIGS. 5-8 and a workflow diagram illustrating methods in accordance with embodiments of the present invention. According to some embodiments, the methods and systems can be implemented using a customized version of Microsoft® Dynamics CRM 3.0.

Referring to FIG. 5, as part of the approval process, at 500 an application record is created and assigned to the second party (client in FIG. 5) and the asset, such as a property. Once an expression of interest is signed by the second party at 510, the application is updated at 520 and the signed document attached. Once the Client Needs Analysis (CNA) fee is paid by the second party at 530, the application is updated at 540 and fee details completed. An application number is automatically populated at 550 and the application progresses to the next stage at 560. A check is made at 570 to determine if all the prerequisites are met and if not, the user is notified at 580 and the prerequisites are completed at 590.

A customer assessment team (CAT) is assigned at 600 and the CNA review is queued at 610. At 620 and 630, a CAT member is assigned who takes ownership of the task and updates the application at 640 with the CAT review decision at 640. The application is progressed to the next stage at 650. A check is made at 660 to determine if all the prerequisites are met and if not, the user is notified at 670 and the prerequisites are completed at 680.

At 690, if the CAT review is unsuccessful, a “notify user unsuccessful” task is created at 700 and at 710 the second party is notified and the application is closed. If the CAT review is successful, at 720 a client adviser (CA) is informed, for example, by email. At 730, a “create Indicative Purchasing Approval Letter (IPAL)” task is created and queued. At 740 and 750, a team member is assigned who takes ownership of the task and updates the application at 760 with the IPAL document.

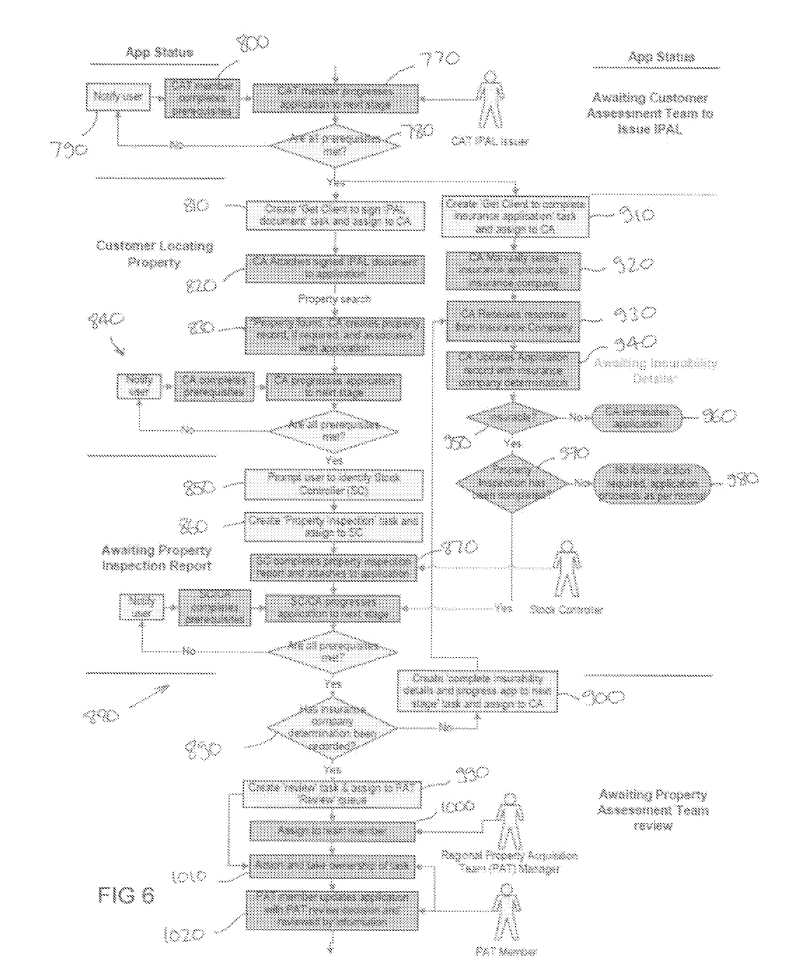

Referring to FIG. 6, at 770, the application is progressed to the next stage and at 780-800 prerequisites are completed if they have not been met. At 810, a task is created requiring the second party to sign the IPAL document, which is attached to the application at 820 once signed. Once the asset, such as a property, has been located, a property record is created and associated with the application at 830. At 840, the application is advanced and a check of prerequisites is made and the user notified if the prerequisites are not met.

At 850 a user is prompted to identify a stock controller (SC) and a property inspection task is created at 860. A property inspection is undertaken and the report attached to the application at 870. At 880, the application is advanced and a check of prerequisites is made and the user notified if the prerequisites are not met.

At 890, if an insurance company determination has not been recorded, a complete insurability task is created at 900, if this has not already been created at 910 followed by the insurance application being sent to the insurance company at 920. A response from the insurance company is received at 930 and the application is updated with the determination of the insurance company at 940. At 950, if the second party is not insurable, the application is terminated at 960. If the second party is insurable, a check is made at 970 that the property inspection has been completed. If so, the workflow continues from 880. If not, the workflow continues from 870.

At 990, a property review task is created and assigned to a Property Assessment Team (PAT). At 1000 and 1010, a team member is assigned who takes ownership of the task and updates the application at 1020 with the PAT review decision.

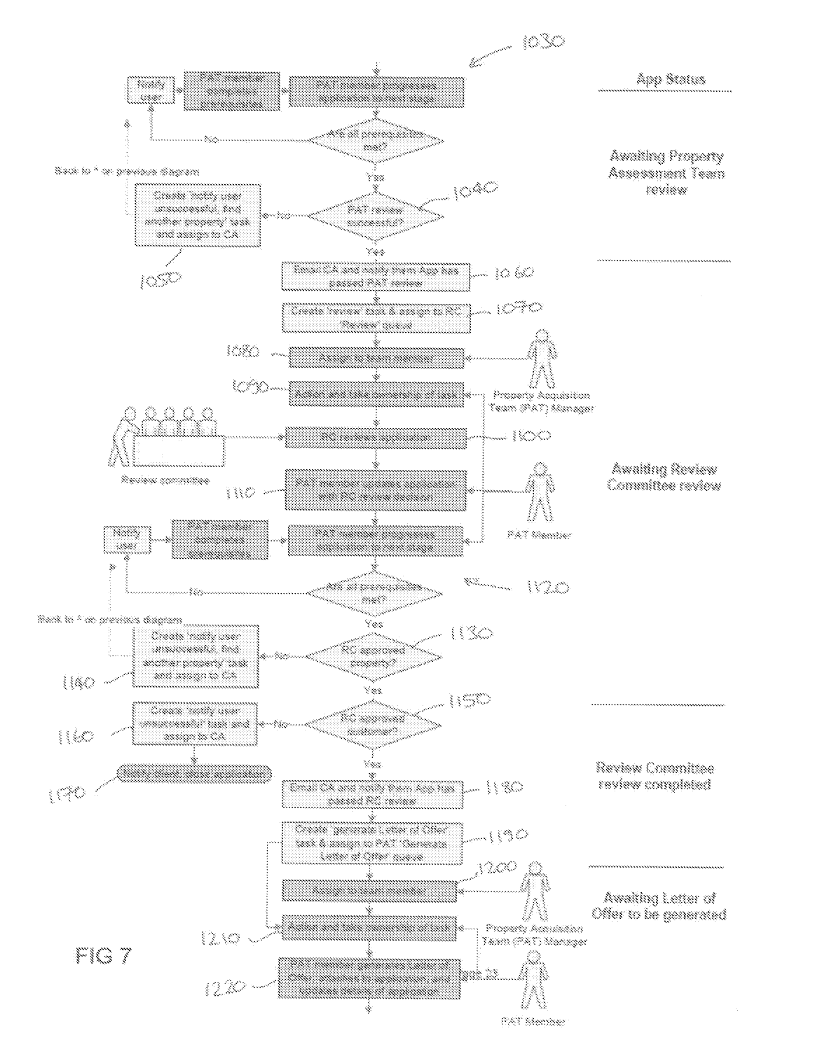

Referring to FIG. 7, at 1030 the application is advanced and a check of prerequisites is made and the user notified if the prerequisites are not met. At 1040, if the PAT review is not successful, at 1050 a task is created to notify the user and find another task and the workflow returns to 830 in FIG. 6. If the PAT review is successful, at 1060, the CA is notified, for example, by email and at 1070 a review task is created and assigned to a Review Committee (RC). At 1080 and 1090, a team member is assigned who takes ownership of the task and following a review of the application by the RC at 1100, updates the application at 1110 with the RC decision. At 1120, the application is advanced and a check of prerequisites is made and the user notified if the prerequisites are not met.

At 1130, if the RC do not approve the property, a task is created to notify the user and find another task and the workflow returns to 830 in FIG. 6. If the RC approves the property at 1130, but not the second party (customer) at 1150, a “notify user unsuccessful task” is created at 1160 and the application is closed at 1170. If the second party (customer) is approved by the RC at 1150, the CA is notified at 1180. A “generate letter of offer” task is created at 1190 and queued. At 1200 and 1210, a team member is assigned who takes ownership of the task and at 1220 generates the letter of offer and updates the application.

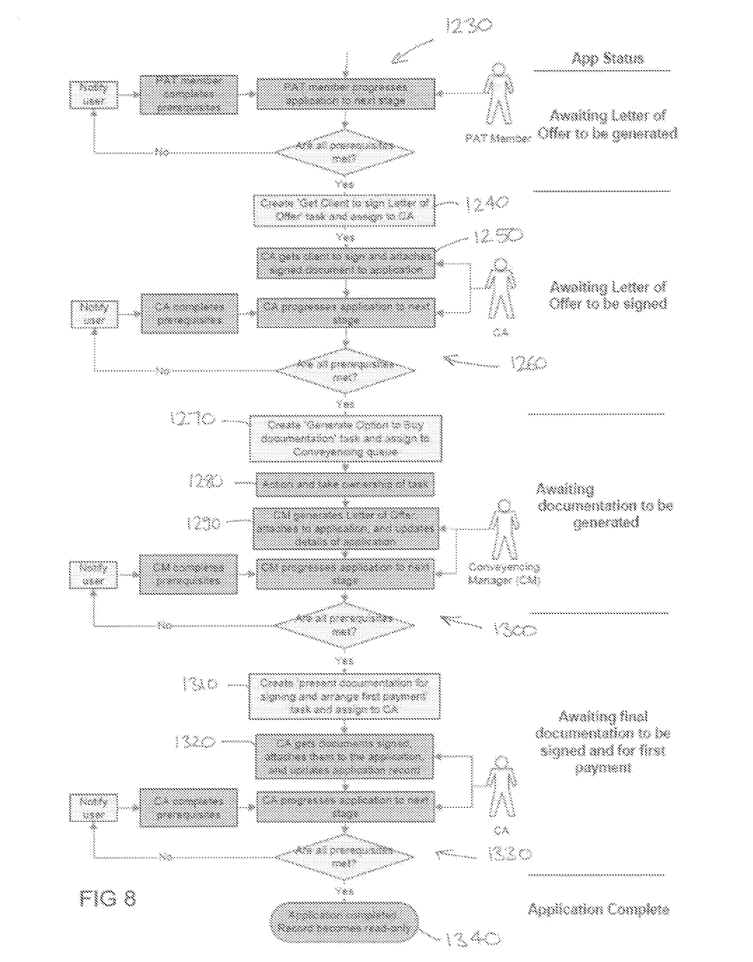

Referring to FIG. 8, at 1230 the application is advanced and a check of prerequisites is made and the user notified if the prerequisites are not met. At 1240, a task is created to have the letter of offer signed by the second party, which is attached to the application once signed at 1250. At 1260, the application is advanced and a check of prerequisites is made and the user notified if the prerequisites are not met. A generate documentation task is created at 1270 and at 1280, a team member is assigned who takes ownership of the task. A conveyancing manager (CM) supervises generation of the letter of offer, which is attached to the application and updates the application at 1290. At 1300, the application is advanced and a check of prerequisites is made and the user notified if the prerequisites are not met. At 1310, a task is created to present documentation for signing to the second party and arrange a first payment. At 1320, the application is updated once the documentation is signed. At 1330, the application is advanced and a check of prerequisites is made and the user notified if the prerequisites are not met. At 1340, the application is completed and becomes a read only record.

It will be appreciated that embodiments of the present invention as described herein relate to methods and systems for financing assets as well as acquiring, managing and occupying assets.

It will be appreciated that references herein to the first party can include references to an agent of or business manager for the first party as described herein. References to the second party also refer to a relation or associate of the second party, for example, regarding the individual occupying the property.

With reference to the embodiment described in relation to FIG. 1, the first party can assist the second party in selecting the asset to be purchased, selecting any goods and/or services to be acquired to modify the asset and/or selecting an alternative asset.

Regarding the alternatives available at 150 of the method shown in FIG. 1, one particular alternative is that the first and second party agree that the second party has the right to settle the purchase or exit the purchase and not settle on the purchase of the asset from the first party at or before the predetermined time. The right to settle is shown as being exercised at 170 in FIG. 2 and the right to not settle and exit the purchase is shown at 180 in FIG. 2.

According to some embodiments, where the purchase contract or agreement contains a pre-agreed purchase price for the asset, this can be a pre-agreed minimum purchase price. According to some embodiments, the agreement can include a mechanism for the pre-agreed minimum purchase price to increase under certain conditions.

With reference to investing a proportion of the payments on behalf of the second party at 160 in FIG. 1, according to some embodiments, the first and second party can appoint a third party, such as an independent stakeholder, under the purchase contract to invest at least a proportion of the payments. Hence, the third component payments, referred to in some embodiments herein as Progressive Savings Payments, are paid to and invested by the third party.

As described herein, the first party introduces an asset acquisition and financing system to the second party to purchase the asset on a deferred settlement basis under the agreement(s) described herein.

According to some embodiments, where the second party exits the purchase agreement, computer program code components are executed to identify to the first party the availability of the asset under the asset acquisition and financing method of the present invention for another purchaser to purchase on deferred settlement terms.

Where restoration of the property or other asset is undertaken by contractors as described above, the contractors can be instructed by the first party, its agent or associated business manager.

It will be appreciated that references herein in relation to FIGS. 3 and 4 to zones, states, districts at regional or national levels are not limiting to embodiments of the invention and are merely labels used to illustrate how the present invention can operate in terms of different geographical demarcations.

It will be appreciated that references herein to the first party obtaining a mortgage or plurality of mortgages includes obtaining funds via other financial instruments or mechanisms, such as loans.

It will be appreciated that in some embodiments of the present invention, the upside risk payment is in the form of a value risk payment, which is payable by the second party if the value of the asset increases beyond a pre-agreed minimum settlement or completion price for the asset or decreases by more than a pre-agreed percentage. The value risk payment is payable where the second party settles or completes the purchase of the asset from the first party at or before the predetermined time.

According to some embodiments described herein, it will be appreciated that the methods and systems can include increasing the pre-agreed purchase price by a pre-agreed percentage of any increase or decrease in the value of the asset at the date of settlement or completion. Alternatively, the variation in the pre-agreed purchase price can be determined by a pre-agreed formula or other calculation relating to any increase or decrease in the value of the asset at the date of settlement or completion.

Where the second party exercises their right to exit and not to settle or not complete the purchase of the asset and the second party receives at least part of the invested savings portion of the payments, according to some embodiments, the second party can receive at least part of the interest accrued by the invested savings portion of the payments. According to some embodiments, the second party receives at least part of the invested savings portion of the payments, and in some embodiments also at least part of the interest accrued by the invested savings portion of the payments, only if the asset is occupied or used for at least a minimum period of time. The minimum period of time can be, but is not limited to, between 6 and 18 months and in some embodiments is 12 months.

The methods and systems of the present invention provide relevant and regular meaningful information to assist the second party on a regular basis to assess and reassess over time during the term of the agreement its timing of entry into a mortgage or chattel lease funding alternatives in respect to their acquisition and timing of settlement of assets. The methods and systems of the present invention provide a solution to the aforementioned problems associated with the strictures of conventional mortgages typically utilized to purchase an asset and in particular to purchase a property. Since the first party is initially purchasing the asset, the approved second party is able to secure the asset, or lease or license it with a view to longer term ownership without the need to wait until they have accumulated a deposit of the magnitude that is often required for a conventional mortgage and without the downside risks of market value fluctuations in the asset. The non-mortgage based, zero-equity process to incubate the purchase can provide the second party with the deferred right or option to decide at any time during the term to proceed with the settlement of the purchase of the asset before the expiry of the predetermined time in the future or to exit from the purchase if, for example, the financial and/or relationship circumstances of the second party change. Additionally, this process provides the second party with time to accumulate a deposit or generate effective equity in the asset over the duration of all or part of the predetermined time whilst immediately enabling the second party to occupy the property.

If the second party chooses to exercise their right or option to purchase or settle the earlier purchase of the asset, the accumulated deposit and/or enhanced market value can enable a mortgage to be secured. If the second party chooses not to settle the earlier purchase of the asset, or not to exercise their option to purchase the asset, or exercises their option not to settle the purchase of the asset (as the case may be under different embodiments) or, in other words, exercises their option or right to terminate the agreement, the second party has typically paid to the first party a sum of money less than what they would have paid to purchase with a conventional mortgage, or has otherwise reduced their risk. In other words, the sum of money paid during the predetermined period is also in almost all cases less than the sum of money they would have paid in mortgage repayments on a like for like basis, during the same period at substantially less risk to the second party and with more flexibility for the second party.

However, the second party does not have the difficulties associated with selling a property if they do not wish to exercise their right to settle or their option to purchase. The second party merely vacates the property. Furthermore, where the second party vacates the property, the second party has a lump sum (the ASF) accrued from invested portions of the payments, less an amount to return the property to an “as new” condition. Any risk reward payment (depending on the particular embodiment) applied by the first party at settlement and the ASF, as well as any break fees that might be applied under some embodiments, are collectively incentives for the second party to complete and settle on the property.

In addition, unlike the traditional mortgage market and property developer rent-to-buy or lease-to-buy schemes, the asset acquisition and financing systems, methods and computer readable media according to embodiments of the present invention, which facilitate asset acquisition and financing undertaken by one party, allow the first party to: [0122] replace one second party consumer with another if required because of a second party exercising its right to exit the purchase; [0123] take asset risk and mitigate it over a predetermined time of several years on a portfolio basis with residual asset value insurance effected for the first party's benefit; [0124] facilitate regular information flow by virtue of the systems managed by the first party or its agent or business manager; [0125] readily communicate with the second party occupier during the term of the deferred purchase agreement.

Accordingly, for the first time, institutional investors can more safely invest millions of dollars in aggregated portfolios of homes, batched for approval, taking front end risk off consumers. Equally, the second party consumers will have the ability to enter home ownership and occupation under a new reduced risk environment with less concern for a predetermined and pre-agreed time over shorter term fluctuations in asset prices and with a safer exit mechanism than a mortgage in times of property price decline.

In summary, the present invention is attractive to the second party because it presents an opportunity to enter the home ownership market with a low entry cost and much less risk to the second party and greater flexibility compared with low equity in conventional mortgages. Should the second party's circumstances change in a particularly adverse manner during the term of the agreement, the present invention also provides a convenient low risk exit mechanism to the second party, compared with low equity positions in conventional mortgages. It also permits ready reassessment of alternatives available to the second party to flex into a mortgage environment during the term of the agreement.

Hence, the methods and systems of the present invention add to the economic wealth of the country and benefit society and the community as a whole. For example, the methods and systems of the present invention assist the banking sector by producing consumers with equity in their own property upon settlement by the second party with the first party with the capacity to meet mortgage payments resulting in a stronger banking sector. Institutional money remains invested within the relevant country with returns on superannuation, life insurance policies, other pension schemes and the like in excess of 15% per annum. The capacity is created for insurance of the capital invested to underwrite returns to institutional investors in the unlikely event of national property price decline over 5 years or more. The prospect of an irreversible trend towards young people no longer being able to afford home ownership is reduced. The methods and systems of the present invention provide a scalable model with capacity in the medium term to be backed by government backed mortgages. Government revenues are increased through higher land tax, stamp duty and income tax receipts. Whilst this may be at the expense of Good and Services Tax (GST), value added tax (VAT), consumption tax or other tax credits in the initial period, this is soon offset by increasing GST, VAT or other consumption tax or other tax receipts as the value add is realized at the end of the incubation period.

Throughout the specification the aim has been to describe the invention without limiting the invention to any one embodiment or specific collection of features. Persons skilled in the relevant art may realize variations from the specific embodiments that will nonetheless fall within the scope of the invention.

1-76. (canceled)

77. A method of a first party financing the acquisition of an asset for a second party, the method including:
the first party approving the second party and the asset selected by the second party for purchase of the asset from the first party on a deferred settlement or completion basis, approval by the first party being via an asset acquisition and financing system;
the first party purchasing the asset via the system; and
the first party and the second party agreeing that upon the second party entering into a purchase agreement via the system to purchase the asset from the first party at or before a predetermined time with a right to occupy or use the asset under a lease or license;
the second party shares in any capital growth arising from the asset from the date of the purchase agreement where the second party settles or completes the purchase of the asset from the first party via the system at or before the predetermined time;
the second party has a right to exit the purchase agreement via the system and not settle or complete the purchase of the asset from the first party at or before the predetermined time;
the first party insures itself at least against the risk of the second party not settling or completing the purchase of the asset from the first party at or before the predetermined time; and
the second party periodically pays payments to the first party, wherein:
a proportion of each payment comprises a collateral risk payment which reflects the risks borne by the first party in undertaking the purchase of the asset and/or allowing the second party to exit the agreement at or before the end of the predetermined time, at least part of the collateral risk payment covering the cost of the insurance taken out by the first party; and
a proportion of each payment comprises a savings portion which is invested on behalf of the second party, at least part of the invested savings portion being returned to the second party at or before the predetermined time; wherein computer program code components are executed by the system to effect the aforementioned steps.

78. The method of claim 77, wherein approval of the second party includes the first party setting an upper limit on the cost of the asset to be purchased.

79. The method of claim 77, including, where the asset is a property, the second party, or a relation thereof, occupying the property during at least part of the predetermined time.

80. The method of claim 77, wherein the asset is one of the following: a residential property; a house; a unit; an apartment; a commercial property; an industrial property; land; a vehicle; a vessel; an animal.

81. The method of claim 77, including the first party and the second party entering into one or more other contracts over an extended term.

82. The method of claim 77, including the second party paying the payments according to one of the following time schemes: immediately; progressively in installments; at one or more future date(s) predetermined by the first party or its agent or manager, the second party or both.

83. The method of claim 77, wherein a proportion of each payment comprises an occupancy or usage fee.

84. The method of claim 77, wherein a value risk payment is payable if the value of the asset increases beyond a pre-agreed minimum settlement or completion price for the asset or decreases by more than a pre-agreed percentage where the second party settles or completes the purchase of the asset from the first party at or before the predetermined time.

85. The method of claim 77, including the first party, or a party appointed by the first and second parties, investing the savings portion on behalf of the second party.

86. The method of claim 77, including the second party exercising their right to settle or complete on the purchase of the asset at or before expiry of the predetermined time.

87. The method of claim 77, including the first or second party arranging a conventional mortgage or other means of finance to purchase the asset for the second party at or before the predetermined time.

88. The method of claim 77, including the second party paying break fees to the first party if the second party exercises their right to exit the purchase and not to settle or complete the purchase of the asset before expiry of the predetermined time.

89. The method of claim 77, including the second party exercising under terms of the agreement their right to exit the purchase and not to settle or complete the purchase of the asset at or before expiry of the predetermined time and handing back possession of the asset to the first party.

90. The method of claim 89, including, where the asset is a property, the second party vacating the property within a predetermined time if the second party exercises their right to exit the purchase and not to settle the purchase of the asset.

91. The method of claim 77, including the first party exercising a put option under terms of an agreement requiring the second party to either exercise or decline their right or option to purchase, lease, license, or settle or complete the purchase of the asset.

92. The method of claim 77, including, where the second party neither settles or completes the purchase nor exercises their right to exit the purchase and not to settle or complete on the purchase of the asset:
considering the second party to be defaulting on the term purchase agreement; and
the first party or another party repossessing the asset.

93. The method of claim 77, including:
the second party exercising their right to exit and not to settle or complete the purchase of the asset; and
the second party receiving at least part of the invested savings portion.

94. The method of claim 93, including the second party receiving at least part of the interest accrued by the invested savings portion.

95. The method of claim 93, wherein the second party receives at lest part of the invested savings portion only if the asset is occupied or used for at least a minimum period of time.

96. The method of claim 95, including the second party receiving at least part of the interest accrued by the invested savings portion.

97. The method of claim 95, wherein the minimum period of time is between 6 and 18 months.

98. The method claim 93, including the second party paying break fees to the first party.

99. The method of claim 77, including, where the asset is a vehicle, vessel or animal, the second party, or a relation or associate thereof, utilizing the vehicle, vessel or animal within the predetermined time.

100. The method of claim 99, including requiring the second party, or a relation or associate thereof, to accrue a threshold distance in the vehicle or vessel or requiring the animal to traverse a threshold distance within the predetermined time.

101. The method of claim 77, including ascertaining a pre-agreed purchase price of the asset.

102. The method of claim 101, including increasing the pre-agreed purchase price by a pre-agreed percentage of, or other calculation relating to, any increase or decrease in the value of the asset at the date of settlement or completion.

103. The method of claim 77, including the second party receiving at least part of the invested savings portion where the second party settles or completes the purchase of the asset from the first party via the system at or before the predetermined time.

104. The method of claim 103, including the second party receiving at least part of the interest accrued by the invested savings portion.

105. The method of claim 77, including the first party returning, applying or offsetting an amount against a pre-agreed purchase price at settlement as an incentive to the second party to settle their purchase contract.

106. The method of claim 77, including the second party paying break fees as an incentive to the second party to settle their purchase contract or exercise their right to purchase the asset.

107. The method of claim 105, wherein the amount returned, applied or offset is similar to collateral risk payments (CRP) less an amount equal to insurance premiums received by the first party up to the predetermined time, less an amount equaling a percentage of any capital growth above a pre-agreed purchase price.

108. The method of claim 105, wherein the amount returned, applied or offset is calculated to be sufficient to assist the second party to obtain a traditional mortgage or other means of finance to purchase the asset at or before the predetermined time.

109. The method of claim 105, wherein the amount returned, applied or offset includes at least part of the invested savings portion.

110. The method of claim 109, wherein the amount returned, applied or offset includes at least part of interest accrued by the invested savings portion.

111. The method of claim 77 including the first party assisting the second party selecting goods and/or services to be acquired to modify or improve the asset.

112. The method of claim 77, wherein the asset acquisition and financing system or another communication device enables the second party to otherwise communicate with the first party.

113. The method of claim 77, including the first party providing the second party with information that enables the second party to assess alternative strategies available to the second party in current market conditions to assist the second party to decide whether or not to exercise their right to exit the purchase or to settle before the predetermined time and switch to either a traditional mortgage or an alternative means of financing the purchase of the asset.

114. The method of claim 77, including providing data storage and/or exchange facilities for the storage and/or exchange of financial and/or valuation information relating to the asset, or its maintenance, the data storage and/or exchange facilities accessible by the first party and/or the second party.

115. An asset acquisition, financing, management and/or occupation system to enable a first party to finance the acquisition of the asset for a second party, the system comprising:
an input device coupled to be in communication with a processor, wherein:
in response to data about the asset selected by a second party for purchase on a deferred settlement or completion basis from the first party entered via the input device, the second party having been approved by a first party, computer program code components are executed by the processor to determine whether said asset is an asset approved by a first party;
computer program code components are executed by the processor to generate a purchase agreement between the first party and the second party for the second party to purchase the asset from the first party via the system at or before a predetermined time with the right to occupy or use the asset under a lease or license; and
computer program code components are executed by the processor to generate the purchase agreement between the first party and the and the second party such that:
the second party shares in capital growth arising from the asset from the date of the agreement where the second party settles or completes the purchase of the asset from the first party via the system at or before a predetermined time;
the second party has a right to exit the purchase agreement via the system and not settle or complete the purchase of the asset from the first party at or before the predetermined time;
the first party insures itself at least against the risk of the second party not settling or completing the purchase of the asset from the first party at or before the predetermined time; and
the second party periodically pays payments to the first party, wherein:
a proportion of each payment comprises a collateral risk payment which reflects the risks borne by the first party in undertaking the purchase of the asset and/or allowing the second party to exit the agreement at or before the end of the predetermined time, at least part of the collateral risk payment covering the cost of the insurance taken out by the first party; and
a proportion of each payment comprises a savings portion which is invested on behalf of the second party, at least part of the invested savings portion being returned to the second party at or before the end of the predetermined time.

116. The system of claim 115, comprising computer program code components executed by the processor to set an upper limit on the cost of the asset to be purchased.

117. The system of claim 115, comprising computer program code components executed by the processor to record, where the asset is property, the second party, or a relation thereof, occupying the property during at least part of the predetermined time.

118. The system of claim 115, wherein the asset is one of the following; a residential property; a house; a unit; an apartment; a commercial property; an industrial property; land; a vehicle; a vessel; an animal.

119. The system of claim 115, comprising computer program code components executed by the processor to generate one or more other contracts over an extended term between the first party and the second party.

120. The system of claim 115, comprising computer program code components executed by the processor to process the payments to the first party made by the second party.

121. The system of claim 115, wherein the payments made by the second party are according to one of the following time schemes: immediately; progressively in installments; at one or more future date(s) predetermined by the first party, the second party or both.

122. The system of claim 115, wherein a proportion of each payment comprises an occupancy or usage fee.

123. The system of claim 115, wherein a value risk payment is payable if the value of the asset increases beyond a pre-agreed minimum settlement price for the asset or decreases by more than a pre-agreed percentage where the second party settles or completes the purchase of the asset from the first party at or before the predetermined time.

124. The system of claim 115, comprising computer program code components executed by the processor to invest the savings portion on behalf of the second party.

125. The system of claim 115, comprising computer program code components executed by the processor to effect the second party exercising their right to settle or complete on the purchase of the asset via the input device at or before expiry of the predetermined time.

126. The system of claim 115, comprising computer program code components executed by the processor to arrange a conventional mortgage or other means of finance to purchase the asset at or before the predetermined time

127. The system of claim 115, comprising computer program code components executed by the processor to effect the payment of break fees by the second party to the first party if the second party exercises their right to exit the purchase and not settle or complete the purchase of the asset before expiry of the predetermined time.

128. The system of claim 115, comprising computer program code components executed by the processor to effect the second party settling or completing the purchase of the asset at or before expiry of the predetermined time.

129. The system of claim 115, comprising computer program code components executed by the processor to effect the first party exercising a put option under terms of an agreement requiring the second party to either exercise or decline their right or option to purchase, lease, license, or settle or complete the purchase of the asset.

130. The system of claim 115, comprising computer code components executed by the processor to effect the second party exercising, under terms of an agreement, their right not to settle or not to complete the purchase of the asset and hand back possession of the asset to the first party.

131. The system of claim 115, comprising computer program code components executed by the processor to effect repossession of the asset by the first party or another party where the second party neither settles nor completes the purchase nor exercises their right not to settle or not to complete on the purchase of the asset and the second party is considered to be defaulting on the term purchase agreement.

132. The system of claim 115, comprising:
computer program code components executed by the processor to effect the second party exercising their right to exit and not to settle or complete the purchase of the asset; and
computer program code components executed by the processor to transfer at least part of the invested savings portion of the payments to the second party.

133. The system of claim 132, comprising computer program code components executed by the processor to effect the second party receiving at least part of the interest accrued by the invested savings portion of the payments.

134. The system of claim 132, comprising computer program code components executed by the processor to effect the second party receiving at least part of the invested savings portion of the payments only if the asset is occupied or used for at least a minimum period of time.

135. The system of claim 134, comprising computer program code components executed by the processor to effect the second party receiving at least part of the interest accrued by the invested savings portion of the payments.

136. The system of claim 134, wherein the minimum period of time is between 6 and 18 months.

137. The system of claim 132, comprising computer program code components executed by the processor to effect the second party paying break fees to the first party.

138. The system of claim 115, comprising computer program code components executed by the processor to record, where the asset is a vehicle, vessel or animal, the second party, or a relation or associate thereof, utilising the vehicle, vessel or animal within the predetermined time.

139. The system of claim 138, comprising computer program code components executed by the processor to record the second party, or a relation or associate thereof, accruing a threshold distance in the vehicle or vessel or to record the animal traversing a threshold distance within the predetermined time.

140. The system of claim 115, comprising computer program code components executed by the processor to ascertain a purchase price of the asset.

141. The system of claim 140, comprising computer program code components executed by the processor to calculate an increase in the purchase price by a pre-agreed percentage of, or other calculation relating to, any increase or decrease in the value of the asset at settlement or completion.

142. The system of claim 115, comprising computer program code components executed by the processor to effect the second party receiving at least part of the invested savings portion of the payments where the second party settles or completes the purchase of the asset from the first party via the system at or before the predetermined time.

143. The system of claim 142, comprising computer program code components executed by the processor to effect the second party receiving at least part of the interest accrued by the invested savings portion of the payments.

144. The system of claim 115, comprising computer program code components executed by the processor to effect the first party returning, applying or offsetting an amount against a pre-agreed purchase price at settlement or completion as an incentive to the second party to settle their purchase contract.

145. The system of claim 115, comprising computer program code components executed by the processor to effect payment of break fees by the second party as an incentive to the second party to settle or complete their purchase contract or exercise their option or right to purchase the asset.

146. The system of claim 144, wherein the amount returned, applied or offset is similar to collateral risk payments (CRP) less an amount equal to insurance premiums received by the first party up to the predetermined time, less an amount equaling a percentage of any capital growth, or other calculation amount, above a pre-agreed purchase price.

147. The system of claim 144, comprising computer program code components executed by the processor to calculate whether the amount returned, applied or offset is sufficient to assist the second party to obtain a traditional mortgage or other means of finance to purchase the asset at or before the predetermined time.

148. The system of claim 144, wherein the amount returned, applied or offset includes at least part of the invested savings portion.

149. The system of claim 144, wherein the amount returned, applied or offset includes at least part of interest accrued by the invested savings portion.

150. The system of claim 115, comprising computer program code components executed by the processor to effect the selecting of goods and/or services by the first party or the second party to be acquired to modify or improve the asset.

151. The system of claim 115, comprising computer program code components executed by the processor to provide the second party with information that enables the second party to assess alternative strategies available to the second party in current market conditions to assist the second party to decide whether or not to exercise their right to settle early or complete early their purchase and to switch to either a traditional mortgage or an alternative means of financing the purchase of the asset.

152. The system of 115, comprising data storage and/or exchange facilities coupled to be in communication with the processor for the storage and/or exchange of financial and/or valuation information relating to the asset, the data storage and/or exchange facilities accessible by the first party and/or the second party.

153. A method of a first party financing the acquisition of assets for second parties via a computer implemented asset acquisition and financing system and managing occupation or usage of the assets by the second parties via the system, the method including:
a first party acquiring a plurality of mortgages or other funds with or from a mortgage provider, financial institution or other fund provider for investment by the first party or another party in a plurality of assets via the asset acquisition and financing system, each said asset selected by one of a plurality of second parties for purchase on a deferred settlement or completion basis from the first party or another party, the plurality of assets and the plurality of second parties approved by the first party;
the first party agreeing with each of the second parties via a respective purchase agreement generated by the asset acquisition and financing system that:
the second parties have a right to settle or complete the purchase of their respective asset or to exit the purchase and to not settle or not complete on the purchase of their respective asset from the first party at or before a predetermined time;
the second parties share in any capital growth arising from their respective one of the assets from the date of the respective agreement where the second parties settle or complete the purchase of their respective asset from the first party via the system at or before a predetermined time;
the first party insures itself at least against the risk of one or more of the second parties not settling or not completing the purchase of the asset from the first party at or before the predetermined time; and
the second parties share in any capital growth arising from their respective one of the assets from the date of the respective agreement where the second parties settle or complete the purchase of their respective asset from the first party via the system at or before a predetermined time;
the first party insures itself at least against the risk of one or more of the second parties not settling or not completing the purchase of the asset from the first party at or before the predetermined time; and
the second parties periodically pay payments to the first party, wherein:
a proportion of each payment comprises a collateral risk payment which reflects the risks borne by the first party in undertaking the purchase of the asset and/or allowing the second party to exit the agreement at or before the end of the predetermined time, at least part of the collateral risk payment covering the cost of the insurance taken out by the first party; and
a proportion of each payment comprises a savings portion which is invested on behalf of the respective second parties, at least part of the invested savings portion being returned to the second party at or before the predetermined time.

154. The method of claim 153, including the first party acquiring legal or equitable title or ownership or partial ownership in the assets from another party at or prior to or after its agreement with one or more of the second parties that the second parties have a right to settle or complete or to exit the purchase and to not settle or not complete on the purchase of their respective asset from the first party at or before the predetermined time.

155. The method of claim 153, including the first party entering into a contract for settlement or completion over a predetermined term with each second party.

156. The method of claim 153, wherein a proportion of each payment comprises an occupancy or usage fee.

157. The method of claim 153, wherein a value risk payment is payable if the value of the asset increases beyond a pre-agreed minimum settlement price for the asset or decreases by more than a pre-agreed percentage where the second party settles or completes the purchase of the asset from the first party at or before the predetermined time.

158. The method of claim 153, including:
one or more of the second parties exercising their right to exit and not to settle or not to complete the purchase of their respective asset; and
each second party exercising their right to exit and not settle or not complete receiving at least part of the invested savings portion of the payments.

159. The method of claim 158, including each second party exercising their right to exit and not settle or not complete receiving at least part of the interest accrued by the invested savings portion of the payments.

160. The method of claim 158, wherein each second party exercising their right to exit and not settle or not complete receives at least part of the invested savings portion of the payments only if the asset is occupied or used for at least a minimum period of time.

161. The method of claim 160, including each second party exercising their right to exit and not settle or not complete receiving at least part of the interest accrued by the invested savings portion of the payments.

162. The method of claim 160, wherein the minimum period of time is between 6 and 18 months.

163. The method of claim 158, including each second party exercising their right to exit and not settle or not complete paying break fees to the first party.

164. The method of claim 153, including one or more of the second parties receiving at least part of their invested savings portion of their payments where the respective second party settles or completes the purchase of their asset from the first party via the system at or before the predetermined time.

165. The method of claim 164, including each second party settling or completing their purchase receiving at least part of the interest accrued by their invested savings portion of their payments.

166. The method of claim 153, including ascertaining a pre-agreed purchase price of the asset payable upon settlement or upon completion.

167. The method of claim 166, including increasing the pre-agreed purchase price by a pre-agreed percentage of, or other calculation relating to, any increase or decrease in the value of the asset at the date of settlement or completion.

168. A machine readable medium having recorded thereon a program of instructions for causing a machine to perform a method of a first party financing the acquisition of an asset for a second party, the method including:
The first party approving the second party and the asset selected by the second party for purchase on a deferred settlement or completion basis via an asset acquisition and financing system;
The first party purchasing the asset via the system; and
The first party and the second party agreeing that upon the second party entering into a purchase agreement via the system to purchase the asset from the first party with a right to occupy or use the asset under a lease or license:
The second party shares in any capital growth arising from the asset from the date of the purchase agreement where the second party settles or completes the purchase of the asset from the first party via the system at or before a predetermined time;
the second party has a right to exit the purchase agreement via the system and not settle or not complete the purchase of the asset from the first party at or before the predetermined time;
the first party insures itself at least against the risk of the second party not settling or not completing the purchase of the asset from the first party at or before the predetermined time; and
the second party periodically pays payments to the first party, wherein:
a proportion of each payment comprises a collateral risk payment which reflects the risks borne by the first party in undertaking the purchase of the asset and/or allowing the second party to exit the agreement at or before the end of the predetermined time, at least part of the collateral risk payment covering the cost of the insurance taken out by the first party; and
a proportion of each payment comprises a savings portion which is invested on behalf of the respective second parties, at least part of the invested savings portion being returned to the second party at or before the predetermined time.
